(19) United States
(12) Patent Application Publication
(10) Pub. No.: US 2016/0342693 A1
(43) Pub. Date: Nov. 24, 2016

(54) AUTOMATED COMPATIBILITY MATCHING SYSTEM FOR DOGS AND DOG OWNERS

(71) Applicant: BARKHAPPY INC., AUSTIN, TX (US)

(72) Inventor: Ninis Samuel, Austin, TX (US)

(73) Assignee: BARKHAPPY INC., AUSTIN, TX (US)

(21) Appl. No.: 14/718,998

(22) Filed: May 21, 2015

(51) Int. Cl. G06F 17/30; G06Q 50/00

(52) U.S. Cl. CPC G06F 17/30867; G06Q 50/01

(57) ABSTRACT

An infrastructure and methodologies to support automated matching of compatible dogs based on geo-proximity and dog profile/preference information. In various embodiments, a dog owner establishes a profile for a first dog by entering profile/preference information via a downloadable application. Such information may include the dog's physical characteristics, compatibility information relating to interaction with other dogs, geolocation information, etc. This information, as well as like information relating to other dogs, may be stored in a profile database maintained by a cloud/remote server. The server proactively identifies compatible dogs by applying configurable matching criteria to the profile database. Proximity thresholds may be utilized to limit matches based on real-time or stored geolocation information. Upon detecting a match between the first dog and a second dog, an automated suggested match notification is communicated to a mobile device associated with the first dog. Options for interacting with the second dog may also be presented.

### BACKGROUND OF THE INVENTION

1. Technical Field of the Invention

The present invention relates generally to social networking systems and, more particularly, to automated matching of compatible dogs based on social profiles and various other criteria.

1. Description Of Related Art

Social networking sites and services have experienced dramatic growth in popularity in recent years. Present social network sites, such as FACEBOOK®, TINDER®, LINKEDIN® and the like are typically web-based and organized around human user profiles. Membership in such social networks is generally comprised of individuals, or groupings of individuals, who may be represented by profile pages and permitted to interact with other humans as determined by the social networking service. Members often share a common bond, social status, or cultural connection with their respective network of contacts.

In many popular social networks, especially profile-centric social networks, activity centers on web pages or social spaces that enable members to manage their own profile, view profiles of others, and communicate and share activities, interests, opinions, status updates, audio/video content, etc. Social networking services may also allow members to track certain activities of other members of the social network, collaborate, connect with existing friends, former acquaintances and colleagues, and establish (via first-person profiles) new connections with other members or dating prospects.

Individual members typically connect to hosted social networking services through existing web-based platforms via a computing device, tablet or smartphone. In so-called “cloud” computing, relevant computing tasks are performed, in a centralized manner, on remote computers/servers which are typically accessed via Internet connections and (virtualized) network infrastructures. One benefit of cloud computing is that it may reduce the relative processing and storage capabilities required by user devices (e.g., a cloud computer may load a webpage or other information accessed by a tablet device and communicate only required information back to the tablet device). Accordingly, recent years have witnessed an ever-growing amount of content, application software and back-end processing being migrated from local to cloud-based data storage and management. Cloud-based services, software and content are typically available on-demand.

### BRIEF DESCRIPTION OF THE SEVERAL VIEWS OF THE DRAWINGS

FIG. 1 illustrates an exemplary network providing automated matching of compatible dogs in accordance with an embodiment of the present disclosure.

FIG. 2 is a functional block diagram representation of a server for performing matching operations and providing suggested match notifications in accordance with an embodiment of the present disclosure.

FIG. 3 is an operational flow diagram illustrating a method for performing matching operations in accordance with an embodiment of the present disclosure.

FIG. 4 illustrates use of exemplary matching criteria and proximity thresholds in accordance with an embodiment of the present disclosure.

FIG. 5 illustrates an exemplary user interface presented on a mobile device for establishing dog profile information in accordance with an embodiment of the present disclosure.

FIG. 6 illustrates an exemplary user interface presented on a mobile device to support entry of dog compatibility information in accordance with an embodiment of the present disclosure.

FIG. 7 illustrates a suggested match notification message as presented on a mobile device in accordance with an exemplary embodiment of the present disclosure.

FIG. 8 illustrates an exemplary suggested match notification as presented on a mobile device in accordance with an embodiment of the present disclosure.

FIG. 9 is a screen shot illustrating a compatible dog profile and exemplary options for responding to an automated suggested match according to an embodiment of the present disclosure.

FIG. 10 is a schematic block diagram of an example mobile device configured to support automated matching operations in accordance with an embodiment of the present disclosure.

FIG. 11 is an operational flow diagram illustrating an exemplary method for performing automated matching operations in a mobile device in accordance with an embodiment of the present disclosure.

### DETAILED DESCRIPTION OF THE INVENTION

In various embodiments of the technology described herein, an infrastructure and methodologies are provided to support automated matching of compatible dogs based on geo-proximity and dog profile/preference information. The disclosed technology is not a natural extension of existing first-person social networks and matching services, and permits novel interaction between animals such as dogs that are unable to benefit from such services or otherwise utilize communication devices meant for human use.

Briefly, in exemplary embodiments a dog owner or caretaker establishes a profile for a dog by entering profile/preference information relating to the dog through a downloadable mobile application. Such information may include the dog's physical characteristics, compatibility information relating to interaction with other dogs, location information (e.g., a zip code or address where the dog resides or frequently spends time), etc.

This information, as well as like information relating to other dogs, may be stored in profile databases maintained by and accessible to a central or cloud/remote server (“server”) that supports the mobile application. The server operates to proactively identify compatible dogs (“matches”) by applying configurable matching criteria to the profile databases. In certain embodiments, proximity thresholds are also utilized to limit matches based on geolocation information.

Upon detecting a match between a first dog and a second dog, the server generates an automated suggested match notification that is communicated to a mobile device associated with the owner of the first dog. The suggested match notification may be displayed automatically when received by an appropriately configured mobile device. A suggested match notification may present the owner of the first dog with options for viewing profiling information relating to the second dog and, in certain embodiments, the owner of the second dog. Various options for interacting with the second dog may also be presented as described in greater detail below.

In one embodiment, the server automatically sends text and/or sound push notifications to an owner's mobile device when a compatible dog match is identified and ready to be viewed. Such suggested match notifications may generally relate to a single compatible dog, and be sent once. Subsequent reminders may be communicated to the mobile device. In certain embodiments, new suggested matches may be communicated on a daily basis, and suggested matches may be created by a remote server in an inclusive list for on demand viewing.

While various devices (such as mobile phones, wearable technology, tablet computing devices (tablets), personal computers (PCs)) are described, other devices not described herein may be used in the interactions described in this disclosure. In addition, although implementation examples are noted herein, the implementation is not limited to such disclosed embodiments.

Further, the embodiments described below may be practiced in a variety of networks that utilize wireless, wired or optical connections, or any combinations thereof. For example, the illustrated communication links may utilize one or more of various transmission media—such as wireless media (radio frequencies, microwave, satellite, infrared, etc.), coaxial cable, shielded twisted pair cable, fiber-optic cable, and power line wires—and operate in accordance with a variety of communication and networking protocols (TCP/IP, UPnP, IPv6, etc.) and standards (3G, 4G, IMT-Advanced, DOCSIS, xDSL, Wi-Fi/802.11x, WiMax, Bluetooth, NFC, etc.). In addition, the communication links may comprise a picocell, femtocell, metrocell, heterogeneous network (HetNet) and/or multi-hop network utilizing a spanning tree protocol, direct wireless connections, peer-to-peer links, etc. One or more of such networks may include the Internet and/or the World Wide Web (“web”), and may be public, private, virtual or any combination thereof.

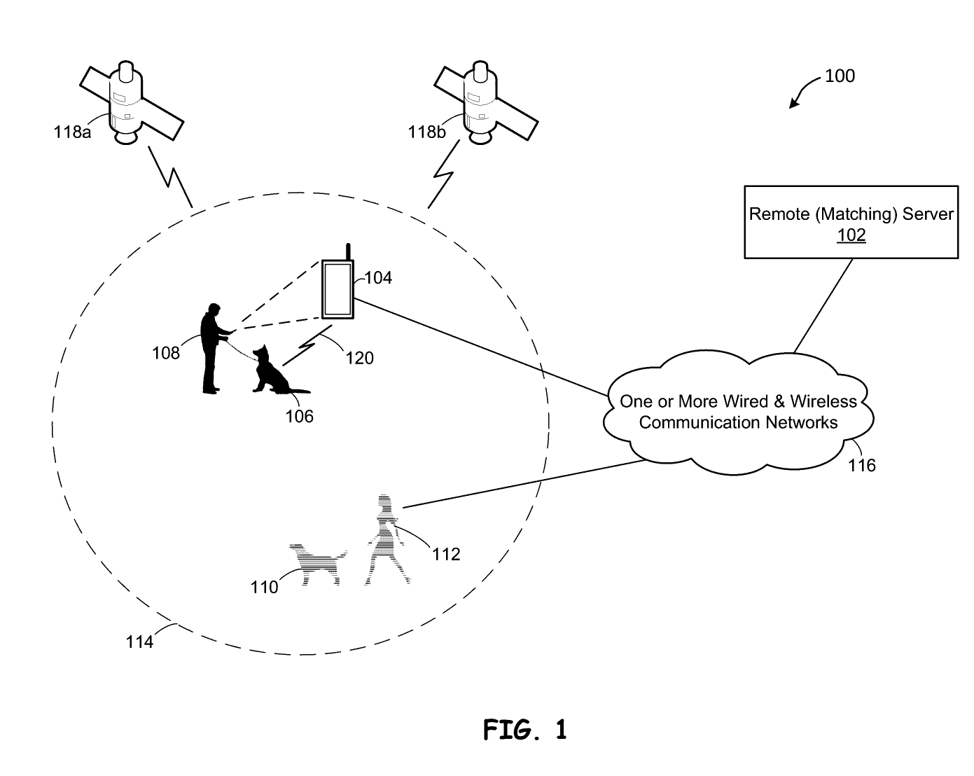

Referring more particularly to FIG. 1, an exemplary network 100 is shown for providing automated matching of compatible dogs in accordance with an embodiment of the present disclosure. The illustrated embodiment includes a remote server 102 configured to perform automated matching operations, as well as a mobile device 104 associated with an owner 108 of a first dog 106. The remote server 102 and mobile device 104 are configured to operate with one or more wired and wireless communication links 116, which may be one or more of a variety of networks such as described above. In the embodiment of network 100, the mobile device 104 may be a smartphone, tablet device, wearable communication device or the like that includes functionality allowing the owner 108 to enter profiling/preference information on behalf of the first dog 106 and/or receive suggested match notifications from the remote server 102.

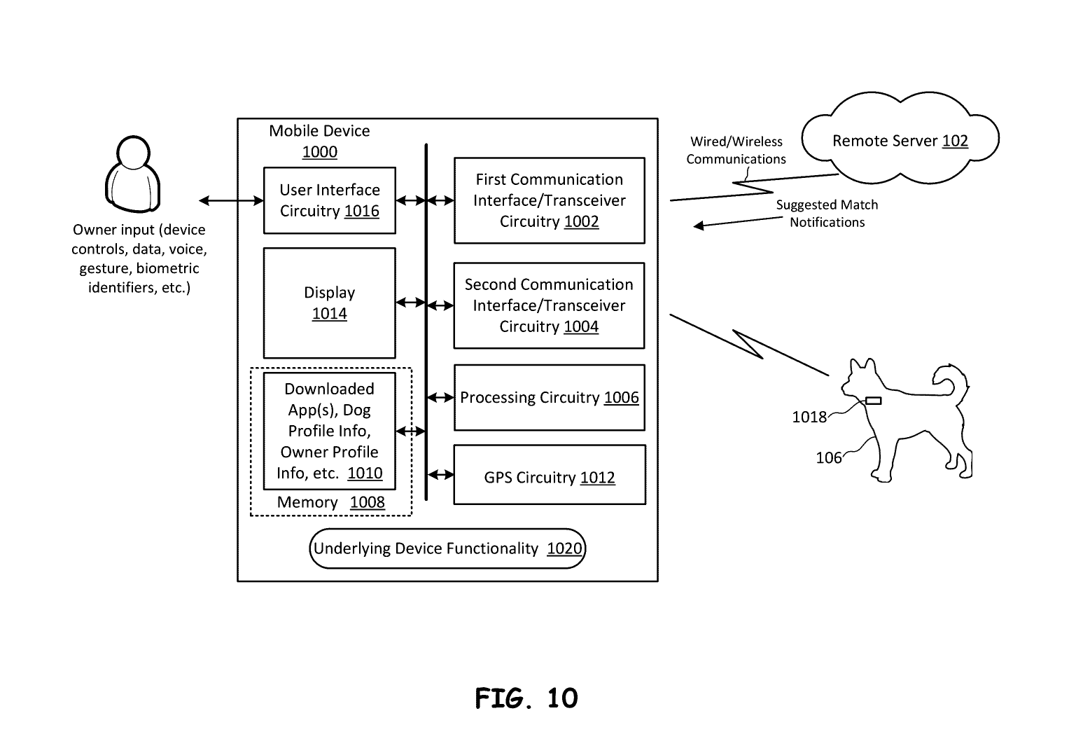

It is noted that other types of devices may be present within network 100. For example, the first dog 106 may have an affixed or embedded tracking device (described in more detail in conjunction with FIG. 10) that is capable of communicating geo-location and other information to mobile device 104, via link 120, and/or remote server 102. A second dog 110 participating in the automated matching system may have a similar tracking device, and the owner 112 of the second dog may carry a second mobile device. As used herein, the term “owner” may include one or more human owners or caretakers of a particular dog. Other entities, such as an animal shelter, may likewise participate in the automated matching system and submit profiling information for dogs (or other animals) that can be used for compatibility matching with dogs whose owners may be seeking to adopt an additional pet.

Various devices within network 100 may have geographical location (geolocation) capabilities to determine the location of the respective devices in a relevant area. In the example of network 100, the mobile device 104 of owner 108, as well as a mobile device of owner 112 and tracking devices affixed to or embedded in dogs 106 and 110 may be linked to GPS satellites 118a and 118b to obtain GPS geolocation information. Timing signals from multiple such GPS satellites may be used to determine the geolocation of a device and generate geospatial metadata. While this data typically comprises latitude and longitude coordinates, it may also include location names and altitude, bearing, distance, and like data. Other technology and methods for determining geolocation information are described herein. In the illustrated example, the mobile device 104 and/or dog 106 are within a boundary 114 defining a geographical region or area corresponding to a proximity threshold for use by remote server 102 in filtering compatible dogs when generating suggested match notifications.

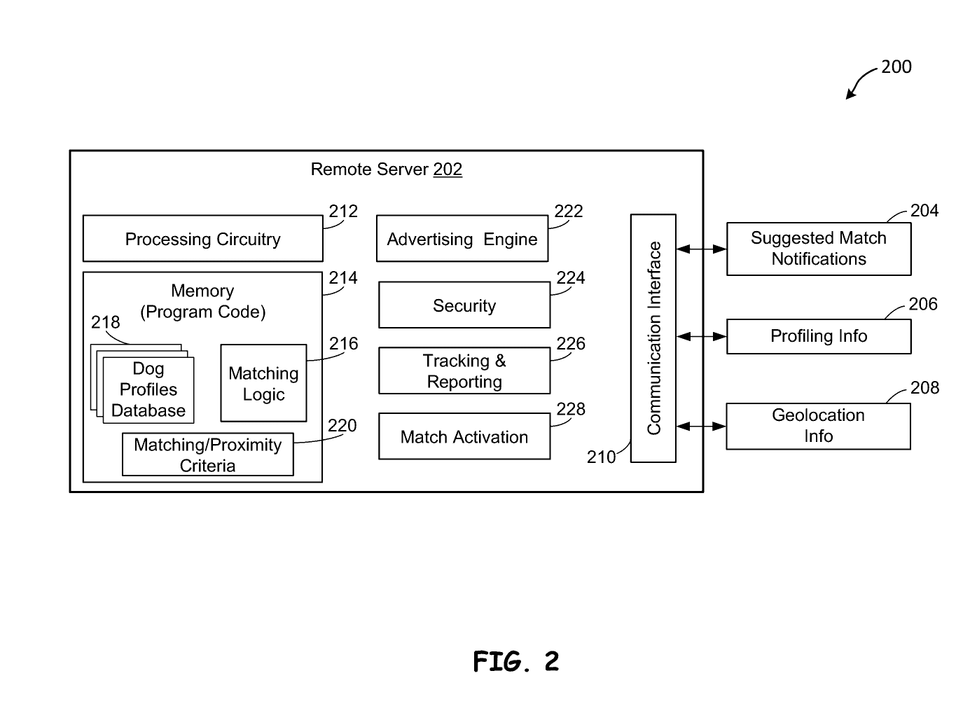

FIG. 2 is a functional block diagram representation 200 of a remote server (“server 202”) for performing matching operations and providing suggested match notifications in accordance with an embodiment of the present disclosure. In this example, the server 202, which may be local, remote or combinations thereof, is operable to output and/or receive suggested match notifications 204, profiling information 206, and related geolocation information 208 via a communication interface 210.

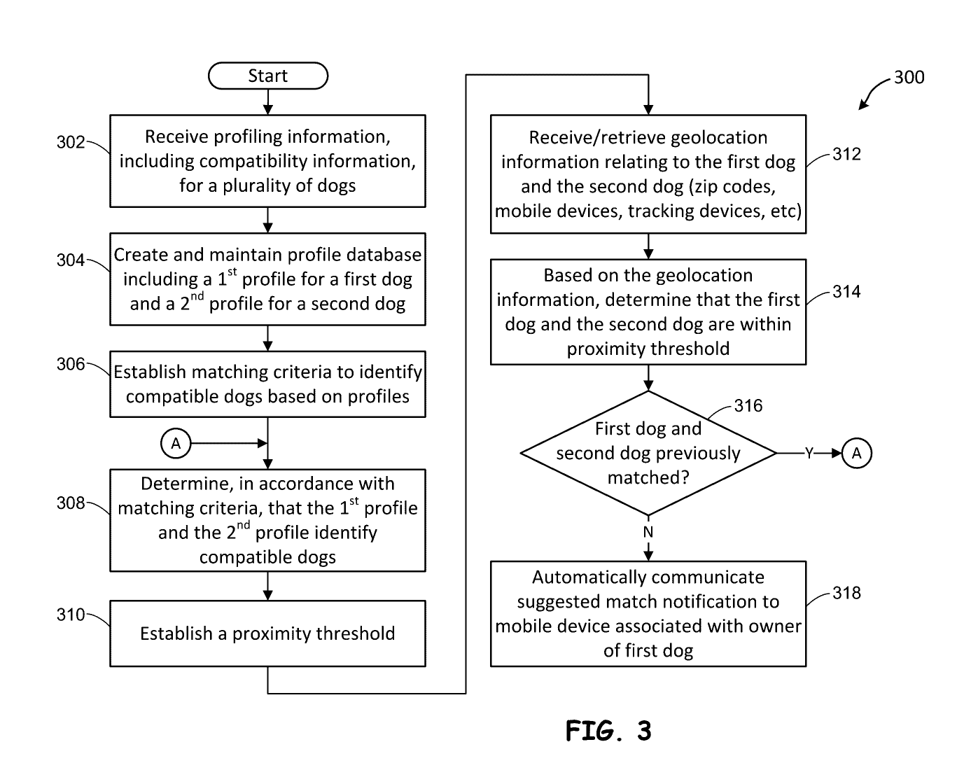

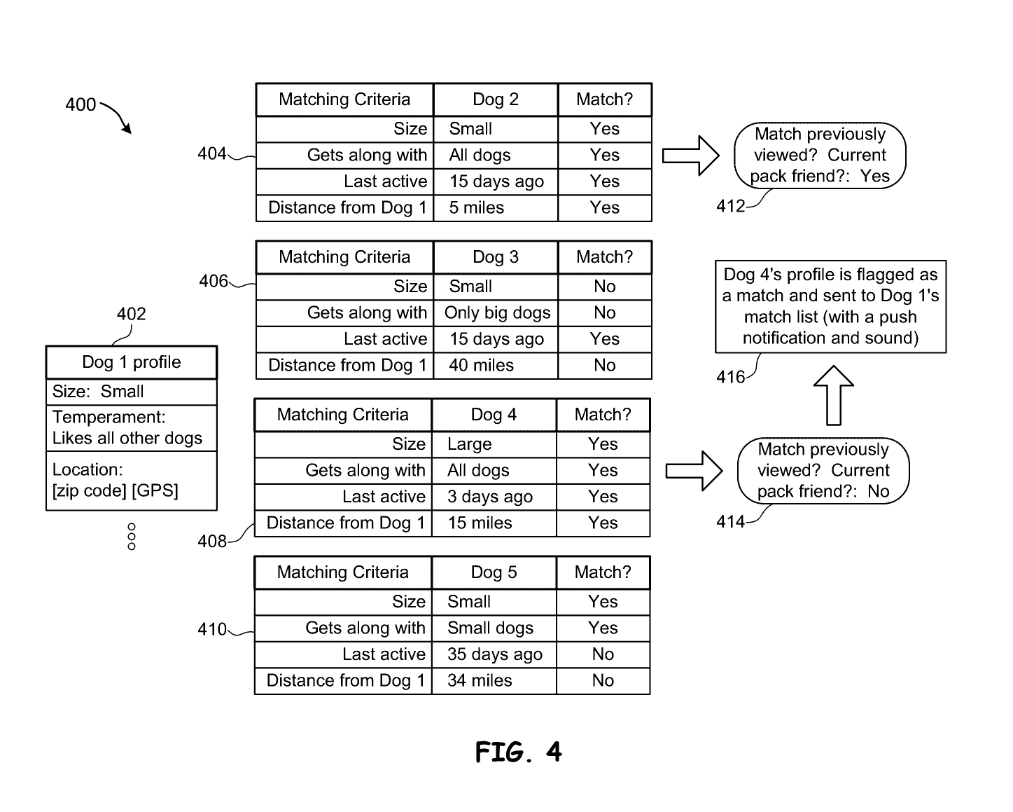

The server 202 includes processing circuitry 212 and memory 214 for storing both program code utilized by the processing circuitry 212 and other data relating to server operations. In the illustrated embodiment, memory 214 includes matching logic 216, as well as a database 218 of dog profiles and matching and proximity criteria 220 for use by the matching logic 216 to identify compatible dogs having complementary profile and geolocation information. Exemplary operation of the matching logic 216 is described more fully below in conjunction with FIGS. 3 and 4.

In addition, the illustrated server 202 includes various functionality/modules for supporting matching operations and fee-based advertising services. In particular, an advertising engine 222 is provided to support in-application advertisements (e.g., when a mobile device is utilizing a free version of a downloadable application that includes automated matching), advertising fee billing and invoicing. The advertising engine 222 may perform other services, such as providing support for competitive bidding for advertising by dog-friendly business, advertisement activation areas, search terms and phrases, search categories, etc. Such services may be securely performed through the use of various security functions provided by security module 224. Security module 224 may also perform user verification/authentication operations and provide restricted access to owner and dog profile information.

In various embodiments, the server 202 also includes a tracking and reporting module 226 configurable to track owner mobile devices and/or dogs having an established profile. The tracking and reporting module 226 may perform other functions such as measuring and generating advertising/marketing campaign statistics for use by advertisers, logging of fee-based interaction with the automated matching system, etc. A match activation module 228 is also provided for performing match activation and monitoring operations (e.g., activating suggested match notifications upon power-on of a relevant mobile device or entry of a mobile device or dog into a particular geographic area).

It is noted that processing circuitry 212 may comprise standalone or distributed hardware, hardware and software, applications executed by processing circuitry, or various combinations thereof, and be configurable to support various functionalities disclosed herein. Further, processing circuitry 212 may be included in a standalone server, cloud-based server farm, and/or the various types of other types of devices (for example, certain operations described as being performed by the server 202 may instead be performed in a computing device associated with a dog owner).

FIG. 3 is an operational flow diagram 300 illustrating a method for performing matching operations in accordance with an embodiment of the present disclosure. The method may be performed, for example, by a remote server such as that described in conjunction with FIG. 2.

Beginning with block 302, profiling information, including compatibility information, is received for a plurality of dogs. Such information may be provided, for example, via a mobile device including a downloadable application that facilitates entry of profile information regarding dogs, or derived from other sources or databases. Next, in block 304, a profile database is created and maintained for a plurality of dogs, including a first profile for a first dog and a second profile for a second dog.

The method continues in block 306, where matching criteria are established for use in identify compatible dogs based on profile information. In block 306, the matching criteria are utilized to determine that the first profile and the second profile include characteristics that identify compatible dogs. Next (or at any other prior stage of the method), the method continues at block 310 where a proximity threshold is established. The proximity threshold may be determined, for example, based on configurable settings in a remote server that may or may not account for owner preference information.

In block 312, geolocation information is then retrieved (e.g., from the profile database) or received (e.g., from mobile devices or dog tracking technology) for the first dog and the second dog. The geolocation information may comprise, for example, zip code or other address information provided by a dog owner, real-time geolocation data from a mobile/tracking device, or historical geolocation data.

Based on the geolocation information, a determination is then made (block 314) that the first dog and second dog are within the relevant proximity threshold. If the first dog and the second dog have not been previously matched as determined in optional block 316, a suggested match notification is automatically sent to (at least) a mobile device associated with the owner of the first dog in block 318. If the first dog and the second dog have been previously matched (or are already “friends”) as determined in block 316, the method returns to block 308 to identify other compatible dogs that meet the criteria established for matching of the first dog. It is noted that various steps of the illustrated method 300 may occur in a different order than described above.

FIG. 4 illustrates use of exemplary matching criteria and proximity thresholds in accordance with an embodiment 400 of the present disclosure. The matching criteria may be utilized in matching operations performed, for example, by the matching logic 216 of FIG. 2 or, to varying degrees, by a computing device associated with an owner of a dog.

In the illustrated embodiment, exemplary matching criteria (including a proximity threshold) is utilized to compare profile information 402 for a first dog (Dog 1) against corresponding profile information for a plurality of other dogs (Dogs 2-5) as represented by blocks 404-410. For example, the profile information 402 for Dog 1 may include fields for size (small), temperament (likes all other dogs) and location (zip code and/or GPS information). In some embodiments, zip code information may be used by the matching logic 216 in lieu of real time geo-location information to perform proximity determinations in order to conserve the battery life of owners' mobile devices, or in the event real time geolocation information is unavailable (e.g., an owner's device is in a reduced power state, or user preference information set in the mobile device does not permit sharing of real time location information). Further, in various embodiments, a dog profile 402-410 may exist as an individual/stand-alone profile for a dog, as a sub-profile of an owner profile, or otherwise be associated with a separate owner profile. All or only a portion of a dog's profile may be used for matching purposes.

In the example of FIG. 4, matching criteria include preset/configurable criteria fields relating to size, temperament, last activity (e.g., number of days since the matching system was last accessed), and a proximity threshold. In this example, last activity field is set to thirty (30) days and a proximity threshold of fifteen (15) miles is utilized. In order to be considered compatible with the profile information 402 for Dog 1, another dog must be compatible with either small or all dogs—dogs that only like large dogs are considered incompatible. Likewise, dogs that only like people are eliminated as possible matches.

Based on the foregoing, application of the matching criteria to profile information 406-410 results in the exclusion of Dog 3 and Dog 5 as possible matches, while Dog 2 and Dog 4 are flagged as compatible with Dog 1 (i.e., all relevant matching criteria are met). A suggested match notification for Dog 2 and Dog 4 may then be communicated to a mobile device associated with Dog 1 (e.g., via a visual/audio push notification).

In alternate embodiments, further processing operations may be performed such that only one suggested match notification (such as a “Daily Match” notification) is generated. For example, and as shown in 412, if a suggested match notification for Dog 2 has previously been communicated to a device associated with Dog 1, or Dog 1 and Dog 2 are already associated as “pack friends”, Dog 2 is excluded as a suggested match. If neither condition is met for Dog 4 (as shown in 414), Dog 4's profile is flagged as a match, included in Dog 1's match list, and a suggested match notification for Dog 4 is communicated to a mobile device associated with Dog 1 as shown in 416.

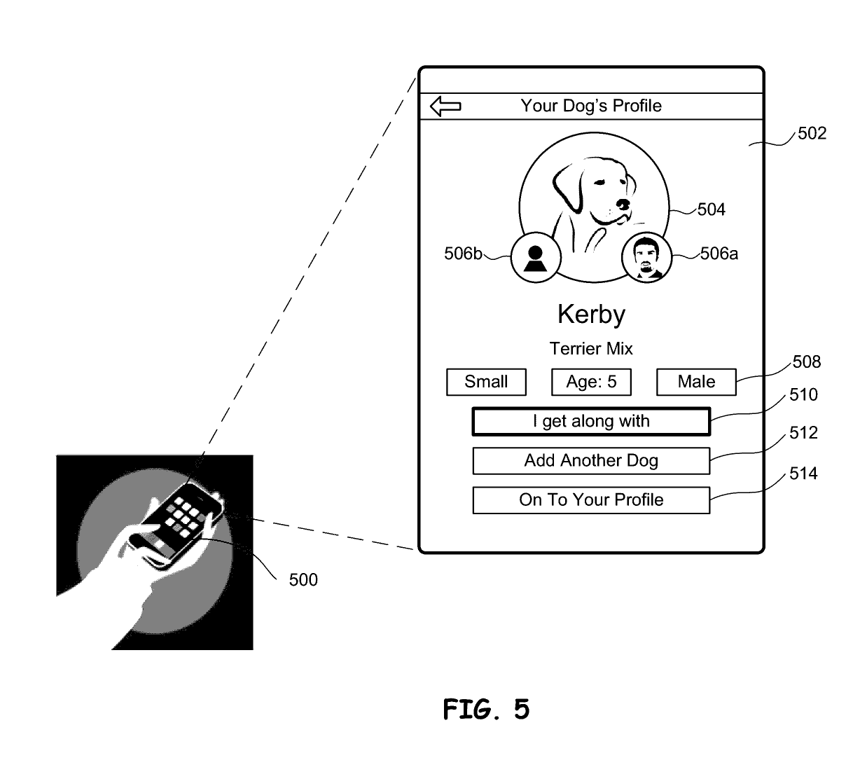

FIG. 5 illustrates an exemplary user interface 502 presented on a mobile device 500 for establishing dog profile information in accordance with an embodiment of the present disclosure. In the illustrated embodiment, the user interface 502 displays various information relating to a dog's profile, and includes menu options for allowing a user (e.g., owner of the dog) to enter additional profile/preference information that may be utilized for automated matching to other dogs having an associated profile that includes compatible information. The user interface 502 may be a feature of and invoked by a software program or downloaded application, such as the BARKHAPPY® application, that includes various other additional features, including features based upon profiles established for dogs.

The example user interface 502 displays a profile picture 504 for a dog (“Kerby”), as well as a profile picture 506a for the owner of the dog. A picture 506b of an additional owner or caretaker may also be displayed. A variety of additional profile information 508 is likewise displayed, including the breed of the dog, the size of the dog, the age of the dog, and the sex of the dog, each of which may be entered or modified by selecting the relevant field. Menu options 510, 512 and 514 are also shown for entering compatibility information (510), adding another dog (512), and creating/modifying an owner profile (514).

It is noted that the illustrated profile information is non-inclusive, and other information, such as preference for certain activities (e.g., playing fetch or swimming) might also be incorporated into a dog's profile for use in matching operations. In addition, the downloadable application can be constructed for use on a wide variety of platforms or operating systems including, by way of example and without limitation, iOS, Android, and Windows-based platforms or other proprietary or open source software platforms or web-based code.

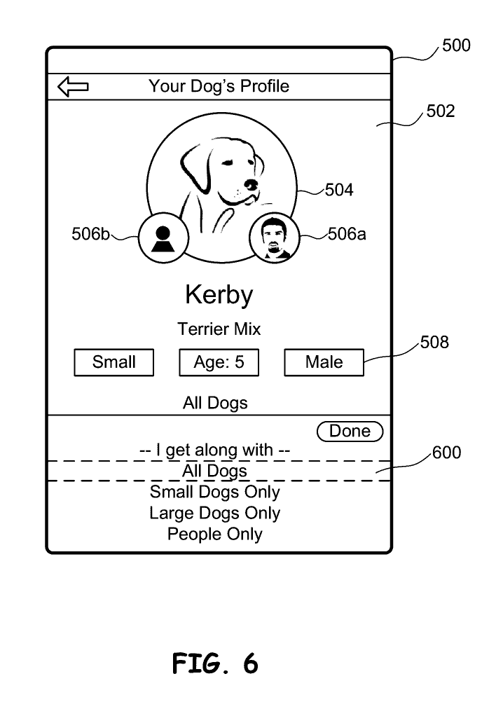

FIG. 6 illustrates an exemplary user interface presented on a mobile device to support entry of dog compatibility information in accordance with an embodiment of the present disclosure. In this example, upon selecting the “I get along with” option 510 of

FIG. 5, a user may be presented with various temperament-related profile options 600 for use in matching operations. These options might include, for example, selections for “All Dogs”, “Small Dogs Only”, “Large Dogs Only” and “People Only”. A wide variety of other profile/preference information may be entered in a like manner by a dog owner to populate, add or modify fields of a dog profile.

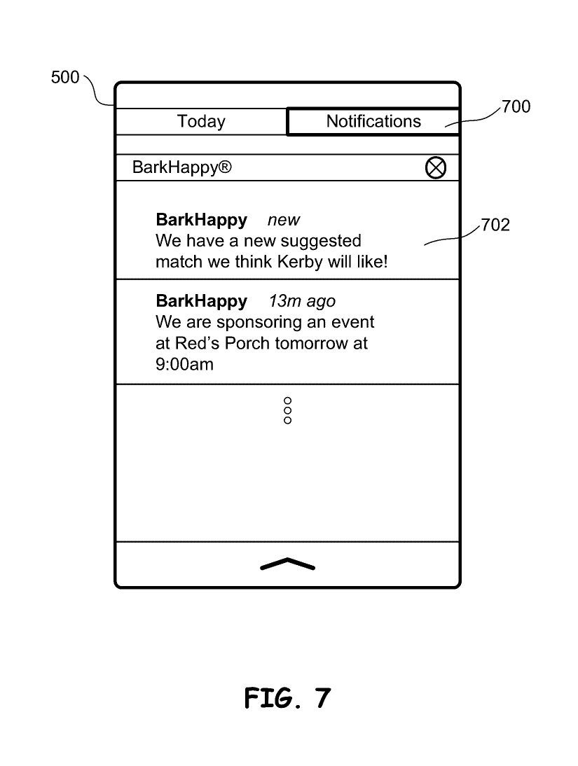

FIG. 7 illustrates a suggested match notification message 702 as presented on a mobile device 500 in accordance with an exemplary embodiment of the present disclosure. The match notification message may be accessible under or automatically displayed through a notification section 700 of a user interface. In the illustrated example, the notification message 702 is text message, provided by or on behalf of a hosted service, reading “We have a new suggested match we think Kerby will like!”

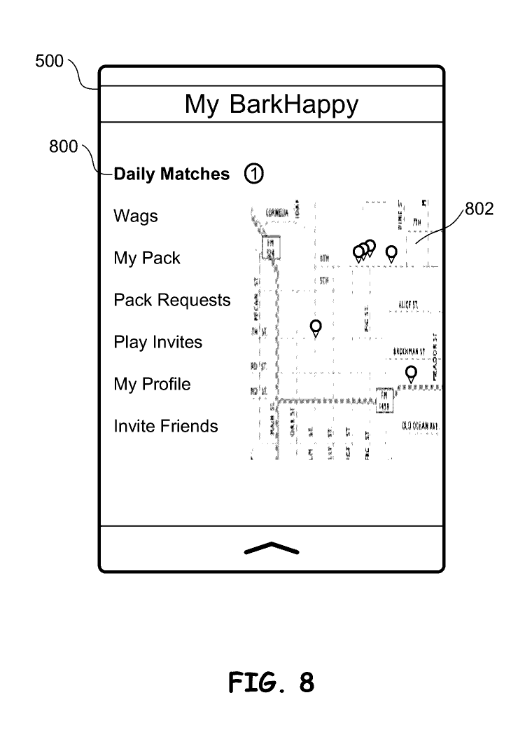

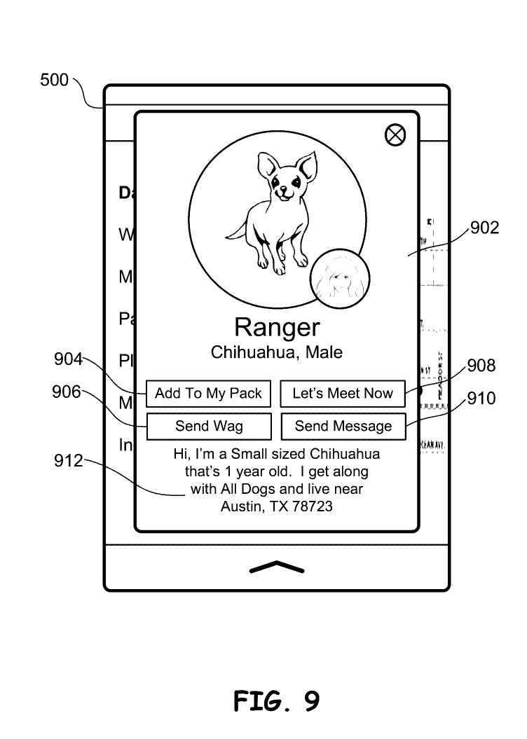

FIG. 8 illustrates an exemplary suggested match notification as presented on a mobile device 500. In this embodiment, various menu options are presented for interaction with other dogs, including an option 800 for displaying “Daily Matches”. Upon selecting option 800, a user may be presented with options for viewing and interacting with the most recent automated suggested match for a particular dog, such as is illustrated in FIG. 9. A badge count may also be displayed in conjunction with the “Daily Matches” option to indicate the number of automatic matches remaining to be viewed.

In the example of FIG. 8, additional functionality is provided, including options for short messaging/acknowledgements (“Wags”), displaying information for associated dogs (“My Pack”), requests to manually match with another dog (“Pack Requests”) and respond to such requests, play date invites (“Play Invites”), viewing and editing a dog profile (“My Profile”) and send friend invitations (“Invite Friends”).

In certain embodiments, an interactive map 802 may also be presented. The interactive map 802 may include location markers or icons for all nearby dogs participating in the matching system, markers for dog friendly parks, bars/restaurants, stores, other miscellaneous dog friendly points of interest, suggested meeting places, upcoming social events, etc. Current and suggested matches may be automatically highlighted on the interactive map 802, and in some contemplated embodiments profile information for other dogs may be accessible by tapping on or otherwise selecting affiliated markers.

FIG. 9 is a screen shot of a mobile device 500 illustrating a compatible dog profile 902 and exemplary options for responding to an automated suggested match according to an embodiment of the present disclosure. The compatible dog profile 902 (in this example, the compatible dog is a male Chihuahua named “Ranger”), including detailed profile information 912, may be presented to a user of the mobile device 500 for viewing after the user selects or otherwise responds to an automated suggested match notification.

Once the compatible dog profile is viewed, the user of the mobile device 500 may be presented with various other options for interacting with the compatible dog. Such options might including adding the compatible dog to a group of other compatible dogs or friends (“Add To My Pack” 904), sending an acknowledgement (“Send Wag” 906), arranging a meeting (“Let's Meet Now” 908) and sending a message (“Send Message” 910).

Referring now to FIG. 10, a schematic block diagram is shown for an example mobile device 1000 configured to support automated matching operations. In the illustrated embodiment, a first communication interface and transceiver circuitry 1002 is operable to perform wireless or wired communications between the mobile device 1000 and a remote server 102 over one or more communication channels. Depending on the capabilities and configuration of the mobile device 1000, communications with the remote server may be unilateral or bidirectional/interactive, and utilize either a proprietary or standardized communication protocol. Communications may include, for example, dog and owner profiling information, matching criteria information, user responses to menu options, suggested match notifications, control signals, audio/video content, interactions with hosted service data, relayed information, etc.

The mobile device 1000 further includes a second communication interface and transceiver circuitry 1004 configured to communicate with and receive geolocation information from a tracking or GPS device 1018 attached to or embedded in a dog 106.

In some embodiments, the geolocation information may be relayed to the remote server 102 via the first communication interface and transceiver circuitry 1002. The dog may be owned by a user of the mobile device 1000, and have associated profile information used for matching and social networking purposes.

In addition, the mobile device 1000 includes processing circuitry 1006 operable to process and manage communications with the remote server 102, execute downloadable applications and other device software, perform graphics processing and security operations, etc. The mobile device 1000 may further incorporate dynamic and/or static memory 1008 for storing, in various embodiments, downloaded or pre-installed application software, dog profile information, owner profile information, etc.

(collectively represented as element 1010). The illustrated mobile device 1000 also includes a display 1014 that, at the direction of processing circuitry 1006, presents an interactive user interface such as shown in FIGS. 5-9.

In certain embodiments, a user and/or dog owner interacts with the mobile device 1000 via user interface circuitry 1016. User input to the mobile device 1000 may include, for example, data entry through a keypad, touchscreen, remote control device, gaming controller, device control buttons, voice or gesture commands, storage device, etc. For example, voice or gesture commands may be utilized to trigger matching services such as those described above. Authorized access to or control of the mobile device 1000 can be facilitated through unique biometric identifiers, passwords, token-based identification, and like authentication means.

The illustrated mobile device 1000 further includes GPS circuitry 1012 that may be utilized to generate geolocation information for use in matching operations. In various alternate embodiments, cellular-based positioning systems, Wi-Fi-based positioning systems, hybrid positioning systems, and/or other indoor/outdoor positioning and tracking technology may be utilized to generate geolocation information relating to the mobile device 1000 or dog 106.

The mobile device 1000 may perform core or underlying functionality 1020. Alternatively, the mobile device may primarily function as a social networking interface or communication device, or be programmable to perform specific functions within a social or matching network. Although not separately illustrated, speaker circuitry may also be included in the mobile device 1000 and be utilized, for example, to provide an audible notification of new suggested matches.

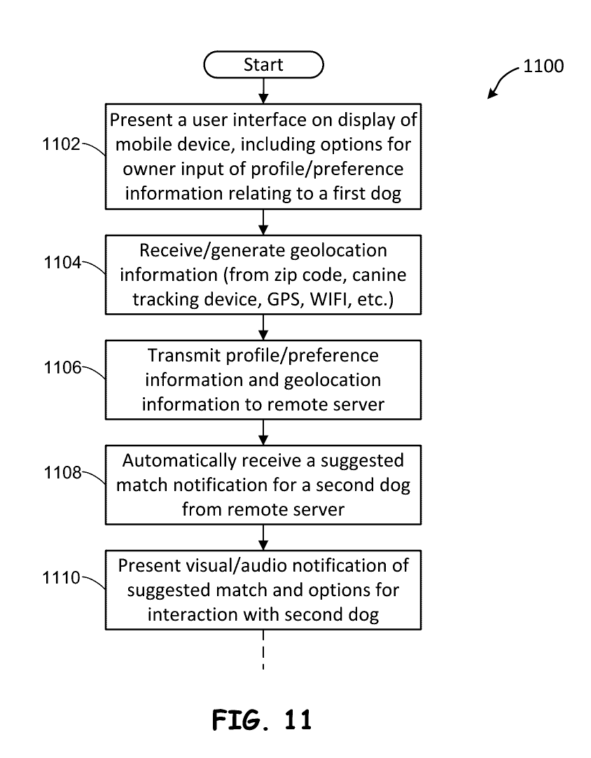

FIG. 11 is an operational flow diagram 1100 illustrating an exemplary method for performing automated matching operations in a mobile device in accordance with an embodiment of the present disclosure. Beginning with block 1102, a user interface is presented on the display of a mobile device (e.g., the mobile device of FIG. 10). The user interface includes various options allowing a dog owner or other device user to input profile/preference information relating to a first dog. The user interface may be presented, for example, upon opening a downloadable application installed on the mobile device. As previously described, dog profile/preference information may include, for example, one or more of dog breed, dog age, dog size, dog temperament, compatibility with other dogs, and preferred activities.

The mobile device also receives and/or generates geolocation information (block 1104). Such geolocation information may be included in the profile information entered via the user interface (e.g., zip code of residence, address where the dog resides, indication of current location on an interactive map, etc.), generated automatically by location circuitry/software included in the mobile device, or received from a tracking device attached to the relevant dog. Next, in block 1106, the profile/preference information and the geolocation information are transmitted to a remote server for use in matching operations. Periodic updates to the geolocation information may also be transmitted to the remote server.

As shown in block 1108, the mobile device may be configured to automatically receive a suggested match notification from the server, based on the information transmitted in block 1106, for a second dog. Upon receipt, the mobile device may be further configured (block 1110) to present visual and/or audible notifications of the suggested match, as well as options for further interaction with the second dog.

While embodiments of the automated compatibility matching system described herein may be supported via one or more features of a downloadable/smartphone application, various functionality may also be supported through a software application for personal computers, or it may reside on a hosted site as an Internet-based application. Similarly, while the automated compatibility matching system may be supported by functionality added to an existing smartphone application (e.g., the BARKHAPPY® application), such functionality is equally suitable for incorporation in a stand-alone application or program.

As may be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may also be used herein, inferred coupling (i.e., where one element is coupled to another element by inference) includes direct and indirect coupling between two items in the same manner as “coupled to”. As may further be used herein, the term “configured to”, “operable to” or “operably coupled to” indicates that an item includes one or more of power connections, input(s), output(s), etc., to perform, when activated, one or more its corresponding functions and may further include inferred coupling to one or more other items. As may even further be used herein, the term “associated with”, includes direct and/or indirect association of separate items and/or one item being embedded within another item.

The term “module” is used in the description of one or more of the embodiments. A module includes a processing module, a processor, a functional block, hardware, and/or memory that stores operational instructions for performing one or more functions as may be described herein. Note that, if the module is implemented via hardware, the hardware may operate independently and/or in conjunction with software and/or firmware. As also used herein, a module may contain one or more sub-modules, each of which may be one or more modules.

As may also be used herein, the terms “processing module”, “processing circuit”, “processing circuitry”, “processor” and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments of the present disclosure have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed subject matter. One of average skill in the art will also recognize that the functional building blocks, and other illustrative blocks, modules and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples of the claimed subject matter. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the one or more embodiments have been expressly described herein, other combinations of these features and functions are likewise possible. The present invention is not limited by the particular examples disclosed herein and expressly incorporates these other combinations.

What is claimed is:

1. A method of locating and matching compatible dogs via mobile devices of dog owners, the method comprising:
receiving, from the mobile devices, profile information for a plurality of dogs;
based on the profile information, storing and maintaining at least a first profile for a first dog and a second profile for a second dog, wherein each of the first profile and the second profile include compatibility information relating to interaction with other dogs;
establishing matching criteria to identify compatible dogs based on the profile information;
determining, in accordance with the matching criteria, that the first profile and the second profile identify compatible dogs;
receiving first geolocation information relating to the first dog;
receiving second geolocation information relating to the second dog;
establishing a proximity threshold;
based on the first geolocation information and the second geolocation information, determining whether the first dog and the second dog are within the proximity threshold; and
responsive to determining that the first dog and the second dog are within the proximity threshold, automatically communicating a suggested match notification for visual presentation on a mobile device associated with an owner of the first dog.

2. The method of claim 1, wherein the suggested match notification includes a link to the second profile.

3. The method of claim 1, wherein the suggested match notification includes an indication of the location of the second dog and an invitation to interact with the second dog.

4. The method of claim 1, wherein the suggested match notification includes profile information relating to the second dog and an invitation to include, in the first profile, the second dog as a friend of the first dog.

5. The method of claim 1, further comprising:
receiving zip code information from the mobile device associated with the owner of the first dog, wherein the proximity threshold is established based, at least in part, on the zip code information.

6. The method of claim 1, further comprising:
receiving preference information from the mobile device associated with the owner of the first dog, wherein the matching criteria are established, at least in part, based on the preference information.

7. The method of claim 1, wherein the first geolocation information and the second geolocation information are derived from the current locations of the mobile communication devices associated with the owners of the first dog and the second dog, respectively.

8. The method of claim 1, wherein the first geolocation information is derived from a location tracking device attached to the first dog.

9. The method of claim 1, wherein the matching criteria includes criteria relating to at least one of dog breed, dog size, dog temperament or preferred activities.

10. The method of claim 1, wherein the first geolocation information is derived from the first profile for the first dog.

11. A server supporting applications installed in a plurality of mobile devices, the server comprising:
a communication interface configured to operate via a network to communicate with and receive profiling information from the plurality of mobile devices, and to receive geolocation information relating to a first mobile device and a second mobile device of the plurality of mobile devices;
processing circuitry operably coupled to the communication interface;
memory coupled to the processing circuitry, the memory maintaining a database of profile information received from the plurality of mobile devices, including a first profile for a first dog associated with a user of the first mobile device and a second profile of a second dog associated with a user of the second mobile device, the profiles of the first dog and the second dog including compatibility information relating to interaction with other dogs; and
program code stored in the memory, wherein the processing circuitry operates according to the program code to:
establish matching criteria to identify compatible dogs;
determine, based on the matching criteria, that the first profile and the second profile identify compatible dogs;
establish a proximity threshold for use in matching dogs;
determine, based at least in part on the geolocation information received from the first mobile device and the second mobile device, that the first dog and the second dog are within the proximity threshold; and
responsive to determining that the first dog and the second dog are within the proximity threshold, automatically communicate a suggested match notification for presentation on at least one of the first mobile device and the second mobile device.

12. The server of claim 11, wherein the suggested match notification includes an invitation to interact with profile information relating to the second dog.

13. The server of claim 11, the communication interface further configured to receive current address-related information from the first mobile device and the second mobile device, wherein the processing circuitry further operates according to the program code to establish the matching criteria based, at least in part, on the current address-related information.

14. The server of claim 11, wherein the matching criteria includes criteria relating to at least one of dog breed, dog size, dog temperament or preferred activities.

15. The server of claim 11 further configured to receive periodic updates to the geolocation information via the communication interface.

16. The server of claim 11, wherein the processing circuitry further operates according to the program code to:
determine if a suggested match notification relating to the second dog has been previously communicated to the first mobile device and, if so, suppressing further such suggested match notifications to the first mobile device.

17. A mobile device, comprising:
a first communication interface configured to support communications with a cloud server;
a second communication interface configured to receive geolocation information from a tracking device attached to a first dog;
a display;
processing circuitry operably coupled to the first communication interface, the second communication interface, and the display;
memory coupled to the processing circuitry, the memory storing application software, wherein upon execution of the application software the processing circuitry operates to:
present a user interface on the display, the user interface visually presenting options for user input of profile information relating to the first dog, the profile information including information for use in establishing matching criteria for identifying dogs compatible with the first dog;
transmit, via the first communication interface, the profile information and the geolocation information to a remote server;
automatically receive, via the first communication interface, a suggested match from the remote server, wherein the suggested match relates to a second dog and is determined, at least in part, based on the profile information and the geolocation information; and
present, on the display, a visual notification of the suggested match, wherein the visual notification provides an option to view profile information relating to the second dog.

18. The mobile device of claim 17, wherein the options for user input of profile information include options relating to one or more of dog breed, dog size, dog temperament or preferred activities.

19. The mobile device of claim 17, wherein the processing circuitry further operates according to the application software to transmit to the remote server, via the first communication interface, periodic updates to the geolocation information received from the second communication interface.

20. The mobile device of claim 17, further comprising:
speaker circuitry coupled to the processing circuitry, wherein the processing circuitry further operates according to the application software to provide an audible notification, via the speaker circuitry, upon receipt of a suggested match from the remote server.
